(19) United States
(12) Patent Application Publication
(10) Pub. No.: US 2025/0021363 A1
(43) Pub. Date: Jan. 16, 2025

(54) SINGLE ADAPTER INSTANCE CONFIGURATION FOR MONITORING MULTIPLE VIRTUAL INFRASTRUCTURES

(71) Applicant: VMware LLC, Palo Alto, CA (US)

(72) Inventors: ROHIT SARAF, Fatehabad (IN); Vineeth Totappanavar, Bangalore (IN); Akansha Srivastava, Lucknow (IN); Venkata Padma Kaki, West Godavari (IN); Aswathy Ramabhadran, Bangalore (IN); Atreyee Bhaduri, Bangalore (IN)

(21) Appl. No.: 18/243,106

(22) Filed: Sep. 7, 2023

(30) Foreign Application Priority Data
Jul. 14, 2023 (IN) 202341047631

(51) Int. Cl. G06F 9/455; G06F 9/4401

(52) U.S. Cl. CPC G06F 9/45558; G06F 9/4401; G06F 2009/45575; G06F 2009/45587; G06F 2009/45591

(57) ABSTRACT

An example method may include generating, during a first boot of a collector appliance, an adapter instance on the collector appliance. Further, the method may include receiving a request to bootstrap a first VCI running in a first virtual infrastructure managed by a first VIM and a second VCI running in a second virtual infrastructure managed by a second VIM. Furthermore, the method may include performing, using the adapter instance, a bootstrapping process of the first VCI to map the adapter instance to the first virtual infrastructure and to install a first monitoring agent, and the second VCI to map the adapter instance to the second virtual infrastructure and to install a second monitoring agent. Further, the method may include collecting, using the adapter instance, performance metrics associated with the first VCI and the second VCI from the first monitoring agent and the second monitoring agent, respectively.

### RELATED APPLICATIONS

Benefit is claimed under 35 U.S.C. 119 (a)-(d) to Foreign application No. 202341047631 filed in India entitled “SINGLE ADAPTER INSTANCE CONFIGURATION FOR MONITORING MULTIPLE VIRTUAL INFRASTRUCTURES”, on Jul. 14, 2023, by VMware, Inc., which is herein incorporated in its entirety by reference for all purposes.

### TECHNICAL FIELD

The present disclosure relates to computing environments, and more particularly to methods, techniques, and systems for configuring a single adapter instance for monitoring multiple virtual infrastructures.

### BACKGROUND

In application/operating system (OS) monitoring environments, a management node that runs a monitoring tool (i.e., a monitoring application) may communicate with multiple virtual infrastructures (e.g., vCenter) to monitor the resources (e.g., virtual computing instances (VCIs)) via a collector appliance (e.g., a cloud proxy). For example, a virtual infrastructure may be implemented in a virtual computing environment or a cloud computing environment. Further, the virtual infrastructure may execute different applications via the VCIs such as virtual machines (VMs), containers, and the like. In such environments, the VCIs may send performance data/metrics (e.g., application metrics, operating system metrics, and the like) from underlying operating system and/or services to the collector appliance. Further, the collector appliance may provide the performance metrics to the monitoring tool for storage and performance analysis (e.g., to detect and diagnose issues).

### BRIEF DESCRIPTION OF THE DRAWINGS

FIG. 1 is a block diagram of an example system, depicting a management application to configure a single adapter instance for monitoring multiple virtual infrastructures;

FIG. 2 is a sequence diagram illustrating sequence of events to configure a single adapter instance for monitoring multiple virtual infrastructures;

FIG. 3 is a flow diagram illustrating an example method for configuring a single adapter instance to monitor multiple virtual infrastructures; and

FIG. 4 is a block diagram of an example management node including non-transitory computer-readable storage medium storing instructions to configure a single adapter instance to monitor multiple virtual infrastructures.

The drawings described herein are for illustrative purposes and are not intended to limit the scope of the present subject matter in any way.

### DETAILED DESCRIPTION

Examples described herein may provide an enhanced computer-based and/or network-based method, technique, and system to configure a single adapter instance for monitoring multiple virtual infrastructures in a computing environment. The paragraphs [0009] to [0013] present an overview of the computing environment, existing methods to monitor the virtual infrastructures, and drawbacks associated with the existing methods.

The computing environment may be a physical computing environment (e.g., an on-premises enterprise computing environment or a physical data center) and/or a virtual computing environment (e.g., a cloud computing environment, a virtualized environment, and the like). The virtual computing environment may be a pool or collection of cloud infrastructure resources designed for enterprise needs. The resources may be a processor (e.g., central processing unit (CPU)), memory (e.g., random-access memory (RAM)), storage (e.g., disk space), and networking (e.g., bandwidth). Further, the virtual computing environment may be a virtual representation of the physical data center, complete with servers, storage clusters, and networking components, all of which may reside in virtual space being hosted by one or more physical data centers. The virtual computing environment may include multiple physical computers (e.g., servers) executing different virtual computing instances (VCIs) or workloads (e.g., virtual machines, containers, and the like). The VCIs may execute different types of applications or software products. Thus, the computing environment may include multiple virtual infrastructures having different VCIs (e.g., virtual machines, containers, and the like) to execute applications. An example virtual infrastructure may include vCenter®, a product offered from VMware, Inc.

Further, performance monitoring of such VCIs has become increasingly important as the performance monitoring may aid in troubleshooting (e.g., to rectify abnormalities or shortcomings, if any) the VCIs, provide better health of the virtual infrastructures, analyse the cost, capacity, and/or the like. An example performance monitoring tool or application or platform may be VMware® vRealize Operations (vROps), VMware Wavefront™, Grafana, and the like. In some examples, the VCIs (e.g., VMs) may include monitoring agents (e.g., Telegraf™, Collectd, Micrometer, and the like) to collect the performance metrics from the respective VCIs and provide, via a network, the collected performance metrics to a collector appliance (e.g., a cloud proxy). Further, the monitoring application may receive the performance metrics from the collector appliance, analyse the received performance metrics, and display the analysis in a form of dashboards, for instance. The displayed analysis may facilitate in visualizing the performance metrics and diagnose a root cause of issues, if any.

Such performance monitoring tools may enable infrastructure administrators and application administrators to collect the run-time performance metrics of the operating system and applications, thus enabling monitoring and troubleshooting respective VCIs. In some examples, for application/operating system monitoring, an adapter instance (e.g., an App OS Adapter) may be created for every virtual infrastructure configuration. For example, agent management requests for a virtual machine (such as bootstrap, un-Bootstrap, manage agents, content upgrade, and the like) may be managed by the adapter instance created for a specific virtual infrastructure configuration. In such performance monitoring tools, the adapter instance to the virtual infrastructure (e.g., vCenter) is a one-to-one relation. In this example, one adapter instance per virtual infrastructure is created in the collector appliance. The collector appliance may be a virtual machine that is responsible for hosting the adapter instances.

In case of high availability, multiple such collector appliances (i.e., cloud proxy machines) are grouped under a collector group to achieve resiliency of component failures and balancing of the data processing load. In this example, the adapter instances have to be created on each of the cloud proxy machines in the collector group to monitor and manage the virtual infrastructures. In other words, a first adapter instance is created in each cloud proxy machine of the collector group corresponding to a first virtual infrastructure, a second adapter instance is created in each cloud proxy machine of the collector group corresponding to a second virtual infrastructure, and the like.

As the number of virtual infrastructure (e.g., vCenter) configurations increases, creating a dedicated adapter instance per virtual infrastructure may cause a significant load on the cloud proxy machines with respect to resource consumptions. Further, managing the adapter instances may be challenging for an administrator as the administrator has to perform activities on the adapter instances such as periodically stop and start the adapter instances for maintenance, perform external Platform Services Controller (PSC) configuration on the adapter instances, and the like.

Examples described herein may provide a management application to configure a single adapter instance for monitoring multiple virtual infrastructures. The management application may deploy a collector appliance corresponding to a monitoring application/tool (e.g., vROps). During a first boot of the collector appliance, the management application may generate an adapter instance on the collector appliance. Further, the management application may receive a request to bootstrap a first VCI of a first virtual infrastructure managed by a first virtual infrastructure manager (VIM) and a second VCI of a second virtual infrastructure managed by a second VIM. Furthermore, the management application may perform, using the adapter instance, a bootstrapping process of the first VCI and the second VCI to install a first monitoring agent and a second monitoring agent, respectively. Further, the management application may collect, using the adapter instance, performance metrics associated with the first VCI and the second VCI from the first monitoring agent and the second monitoring agent, respectively.

With the examples described herein, a single adapter instance may cater requests from multiple virtual infrastructures (e.g., vCenters). Thus, examples described herein may resolve the issues faced by the user due to having multiple adapter (e.g., an App OS Adapter) instances and maintaining the multiple adapter instances. Also, examples described herein may facilitate in achieving significantly better resource consumption of a cloud proxy instance and ease the job of the user with respect to management of the adapter instance.

In the following description, for purposes of explanation, numerous specific details are set forth in order to provide a thorough understanding of the present techniques. However, the example apparatuses, devices, and systems, may be practiced without these specific details. Reference in the specification to “an example” or similar language means that a particular feature, structure, or characteristic described may be included in at least that one example but may not be in other examples.

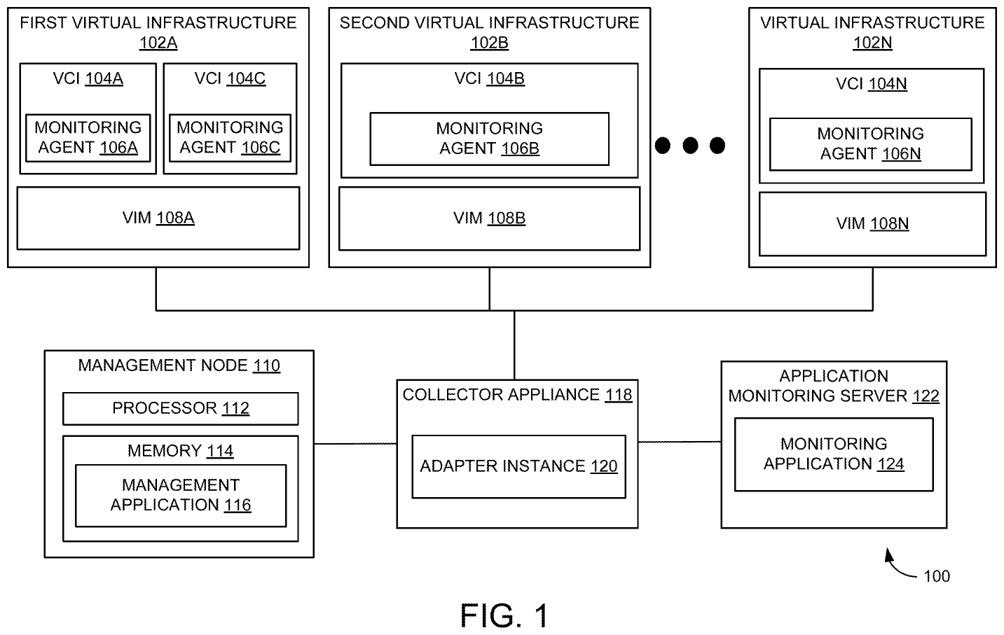

Referring now to the figures, FIG. 1 is a block diagram of an example system 100, depicting a management application 116 to configure a single adapter instance 120 for monitoring multiple virtual infrastructures 102A-102N. Example system 100 may include a computing environment such as a cloud computing environment (e.g., a virtualized cloud computing environment), a physical computing environment, or a combination thereof. For example, the cloud computing environment may be enabled by vSphere®, VMware's cloud computing virtualization platform. The cloud computing environment may include one or more computing platforms that support the creation, deployment, and management of virtual machine-based cloud applications or services or programs. An application, also referred to as an application program, may be a computer software package that performs a specific function directly for an end user or, in some cases, for another application. Examples of applications may include MySQL. Tomcat, Apache, word processors, database programs, web browsers, development tools, image editors, communication platforms, and the like.

As shown in FIG. 1, example system 100 may include multiple virtual infrastructures 102A-102N. An example virtual infrastructure (e.g., one of virtual infrastructures 102A-102N) may refer to a centralized physical facility where servers, network, storage, and other information technology equipment that support business operations exist. Further, components in the virtual infrastructure may include or facilitate business applications, services, data, and the like. For example, the virtual infrastructure may be a software-defined data center (SDDC) with hyperconverged infrastructure (HCI). In SDDC with hyper-converged infrastructure, networking, storage, processing, and security may be virtualized and delivered as a service. The hyper-converged infrastructure may combine a virtualization platform such as a hypervisor, virtualized software-defined storage, and virtualized networking in the virtual infrastructure deployment. An example virtual infrastructure may be a vCenter representing a physical or virtual network of many virtual machines (VMs), such as of the order of thousands of VMs each.

Further, virtual infrastructures 102A-102N may include respective virtual infrastructure managers (VIMs) 108A-108N to deploy different components and manage different virtual computing instances (e.g., VCIs 104A-104N) such as virtual machines, containers, virtual routers, applications, and the like. The virtual machines, in some examples, may operate with their own guest operating systems on a physical computing device using resources of the physical computing device virtualized by virtualization software (e.g., a hypervisor, a virtual machine monitor, and the like). The containers are data computer nodes that run on top of the host operating systems without the need for a hypervisor or separate operating system. The VIM (e.g., 108A-108N) may be a computer program that resides and executes in a central server that is external to the virtual infrastructure, or alternatively, the VIM may run as a VM in one of host computing systems in the virtual infrastructure. An example of a VIM is the vCenter Server®, a product offered from VMware, Inc. VIMs 108A-108N may be configured to carry out administrative tasks for respective virtual infrastructures 102A-102N, including managing host computing systems, VMs running within each computing system, provisioning VMs, migrating VMs from one host to another host, load balancing between host computing systems, and the like.

Further, each VCI (e.g., 104A-104N) may include respective monitoring agents 106A-106N to monitor applications or services or programs associated with VCIs 104A-104N. Monitoring agents 106A-106N may be installed in respective VCIs 104A-104N to fetch the metrics from various components of VCIs 104A-104N. For example, monitoring agents 106A-106N may real-time monitor VCIs 104A-104N to receive the metrics (e.g., telemetry data) associated with an application or an operating system associated with VCIs 104A-104N, respectively. An example monitoring agent may be Telegraf agent, Collectd agent, or the like. Example metrics may include performance metric values associated with at least one of central processing unit (CPU), memory, storage, graphics, network traffic, or the like. Further, monitoring agents 106A-106N may send the performance metrics to a collector appliance 118 (e.g., a cloud proxy (CP), a remote collector to upload data from an VCI environment to monitoring application 124). The remote collector may refer to a service/program that is installed in an additional cluster node (e.g., collector appliance 118). Collector appliance 118 may allow a monitoring application 124 (e.g., vROps Manager) to gather objects into the remote collector's inventory for monitoring purposes. Thus, collector appliance 118 may collect the data from VCIs 104A-104N.

Furthermore, collector appliance 118 may transmit the performance metrics to monitoring application 124 (i.e., a performance monitoring tool such as VMware® vRealize Operations (vROps), VMware Wavefront™, Grafana, and the like) resided in an application monitoring server 122 for storing and analysing the performance metrics. For example, collector appliance 118 may be deployed at a remote location site while monitoring application 124 may be deployed at a primary location. Furthermore, monitoring application 124 may receive the performance metrics, analyse the received performance metrics, and display the analysis in a form of dashboards, for instance. The displayed analysis may facilitate in visualizing the performance metrics and diagnose a root cause of issues, if any.

Further, system 100 may include a management node 110 communicatively connected to virtual infrastructures 102A-102N via a network to manage virtual infrastructures 102A-102N. An example network can be a managed Internet protocol (IP) network administered by a service provider. For example, the network may be implemented using wireless protocols and technologies, such as Wi-Fi, WiMAX, and the like. In other examples, the network can also be a packet-switched network such as a local area network, wide area network, metropolitan area network, Internet network, or other similar type of network environment. In yet other examples, the network may be a fixed wireless network, a wireless local area network (LAN), a wireless wide area network (WAN), a personal area network (PAN), a virtual private network (VPN), intranet or other suitable network system and includes equipment for receiving and transmitting signals.

Management node 110 may include a processor 112. Processor 112 may refer to, for example, a central processing unit (CPU), a semiconductor-based microprocessor, a digital signal processor (DSP) such as a digital image processing unit, or other hardware devices or processing elements suitable to retrieve and execute instructions stored in a storage medium, or suitable combinations thereof. Processor 112 may, for example, include single or multiple cores on a chip, multiple cores across multiple chips, multiple cores across multiple devices, or suitable combinations thereof. Processor 112 may be functional to fetch, decode, and execute instructions as described herein. Further, management node 110 includes memory 114 coupled to processor 112. Memory 114 may include management application 116.

During operation, management application 116 may deploy collector appliance 118 corresponding to monitoring application 124. During a first boot of collector appliance 118, management application 116 may generate an adapter instance 120 on collector appliance 118. Adapter instance 120 may enable monitoring application 124 to receive metrics for VCIs 104A-104N.

Further, management application 116 may receive a request to bootstrap a first VCI 104A of a first virtual infrastructure 102A managed by a first VIM 108A and a second VCI 104B of a second virtual infrastructure 102B managed by a second VIM 108B. Furthermore, management application 116 may perform, using adapter instance 120, a bootstrapping process of first VCI 104A and second VCI 104B to install a first monitoring agent 106A and a second monitoring agent 106B, respectively. In this example, management application 116 may determine whether first virtual infrastructure 102A and second virtual infrastructure 102B are mapped to adapter instance 120. In response to determining that first virtual infrastructure 102A, second virtual infrastructure 102B, or both are not mapped to adapter instance 120, management application 116 may perform, using the adapter instance, the bootstrapping process of the first VCI and the second VCI to map the first virtual infrastructure, the second virtual infrastructure, or both to the adapter instance, and install the first monitoring agent and the second monitoring agent in the first VCI and the second VCI, respectively.

In response to receiving the request to bootstrap first VCI 104A, management application 116 may retrieve a first security certificate of first virtual infrastructure 102A from a virtual infrastructure management adapter deployed in first VIM 108A. Further, management application 116 may perform, using the first security certificate, the bootstrapping process of first VCI 104A running in first virtual infrastructure 102A. Booting or bootstrapping is a process of starting up a computer (e.g., collector appliance, VCI, and the like) from a halted or powered-down condition and loading an operating system into system memory of the computer.

Further, in response to receiving the request to bootstrap second VCI 104B, management application 116 may retrieve a second security certificate of second virtual infrastructure 102B from a virtual infrastructure management adapter deployed in second VIM 108B. Further, management application 116 may perform, using the second security certificate, the bootstrapping process of second VCI 104B running in second virtual infrastructure 102B. Thus, both first virtual infrastructure 102A and second virtual infrastructure 102B are mapped to adapter instance 120 during the bootstrapping process of VCI 104A and VCI 104B, respectively.

Now that first virtual infrastructure 102A and second virtual infrastructure 102B are mapped to adapter instance 120, for any further requests to bootstrap VCIs on first virtual infrastructure 102A and second virtual infrastructure 102B, management application 116 may perform the bootstrapping process of the VCIs to install monitoring agents. For example, management application 116 may receive a request to initiate the bootstrapping process of a third VCI 104C running in first virtual infrastructure 102A. In response to initiating the bootstrapping process of third VCI 104C, management application 116 may retrieve the first security certificate of first virtual infrastructure 102A from the virtual infrastructure management adapter deployed in first VIM 108A. Further, management application 116 may perform, using the first security certificate, the bootstrapping process of third VCI 104C running in first virtual infrastructure 102A to install a third monitoring agent 106C.

Further, management application 116 may collect, using adapter instance 120, performance metrics of an operating system and/or an application associated with first VCI 104A and second VCI 104B from first monitoring agent 106A and second monitoring agent 106B, respectively. For example, VCIs 104A and 104B may communicate with collector appliance 118 to send performance data/metrics (e.g., application metrics, operating system metrics, and the like) from underlying operating system and/or services on the VCIs 104A and 104B. Further, collector appliance 118 may provide the performance metrics to monitoring application 124 for storage and performance analysis (e.g., to detect and diagnose issues).

In an example, management application 116 may generate a global queue corresponding to first virtual infrastructure 102A and second virtual infrastructure 102B in adapter instance 120. Further, management application 116 may collect, using adapter instance 120, the performance metrics of the operating system and/or the application associated with first VCI 104A and second VCI 104B from first monitoring agent 106A and second monitoring agent 106B, respectively, into the global queue.

In another example, management application 116 may generate a first queue and a second queue corresponding to first virtual infrastructure 102A and second virtual infrastructure 102B, respectively, in adapter instance 120. Further, management application 116 may collect, using adapter instance 120, the performance metrics of the operating system and/or the application associated with first VCI 104A managed by first VIM 108A into the first queue. Further, management application 116 may collect, using adapter instance 120, the performance metrics of the operating system and/or the application associated with second VCI 104B managed by second VIM 108B into the second queue.

Thus, examples described herein may provide management application 116 to create a common adapter instance as part of a first boot of the collector appliance 118 (e.g., a cloud proxy machine). Further, management application 116 may manage the server queue as well as virtual infrastructure certificates. For example, the adapter's server queue is a buffered message receiver which is configured in an adapter and attached to a particular virtual infrastructure to collect the performance metrics associated with the virtual infrastructure. In existing methods, the adapter may maintain a map containing virtual infrastructure identifier (e.g., vCenter id) as key and corresponding server queue as value. Thus, existing methods may have a one-on-one mapping between the queue and the virtual infrastructure. With the examples described herein, the dependency is removed. For example, adapter instance 120 may have the global queue that can hold the performance metrics coming from any virtual infrastructure configured in monitoring application 124 (e.g., vROps). Further, the same global queue may be used to collect unmanaged host computing systems (i.e., host computing systems that are not managed by VIMs) metrics. Thus, utilization of the resources associated with the virtual environment may be enhanced as significantly lesser threads may be created in common adapter instance 120 to perform the same operation.

Further, management application 116 may manage virtual infrastructure (e.g., vCenter) certificates. In existing methods, vCenter certificates are stored in adapters to perform Guest Operations on the VCI to install/uninstall agent. The problems with such existing designs may include:
One adapter contains certificates corresponding to a specific vCenter.
Certificates were added to the adapter only on installation of monitoring agent for a first VCI in the vCenter. One time procurement of vCenter certificates may cause issue on expiration. For example, in existing methods, when the certificate gets expired or changed, the adapter has to be deleted from the collector appliance and a rebooting of the collector appliance may be performed to create a new adapter.

Examples described herein may provide an approach to create one adapter to manage multiple virtual infrastructure certificates so that single adapter instance 120 can communicate with the VCIs 104A-104N (e.g., virtual machines) corresponding to different virtual infrastructures 102A-102N (e.g., vCenters). Furthermore, the certificates of virtual infrastructures 102A-102N may be fetched from respective adapters for every agent installation/uninstallation action. Thus, the issue related to certificate expiry may be resolved as it takes significantly less time (e.g., few milliseconds (e.g., 59 milliseconds)) to fetch the certificate as the agent installation operation is not performed frequently. For example, when bootstrapping of 10 virtual machines running on a vCenter is initiated, collector appliance 118 may retrieve the certificate from the vCenter and use the retrieved certificate to perform the bootstrapping process of all the 10 virtual machines.

In some examples, the functionalities described in FIG. 1, in relation to instructions to implement functions of management application 116 and any additional instructions described herein in relation to the storage medium, may be implemented as engines or modules including any combination of hardware and programming to implement the functionalities of the modules or engines described herein. The functions of management application 116 may also be implemented by a processor. In examples described herein, the processor may include, for example, one processor or multiple processors included in a single device or distributed across multiple devices.

Further, the cloud computing environment illustrated in FIG. 1 is shown purely for purposes of illustration and is not intended to be in any way inclusive or limiting to the embodiments that are described herein. For example, a typical cloud computing environment would include many more remote servers (e.g., resources), which may be distributed over multiple virtual infrastructures, which might include many other types of devices, such as switches, power supplies, cooling systems, environmental controls, and the like, which are not illustrated herein. It will be apparent to one of ordinary skill in the art that the example shown in FIG. 1, as well as all other figures in this disclosure have been simplified for ease of understanding and are not intended to be exhaustive or limiting to the scope of the idea.

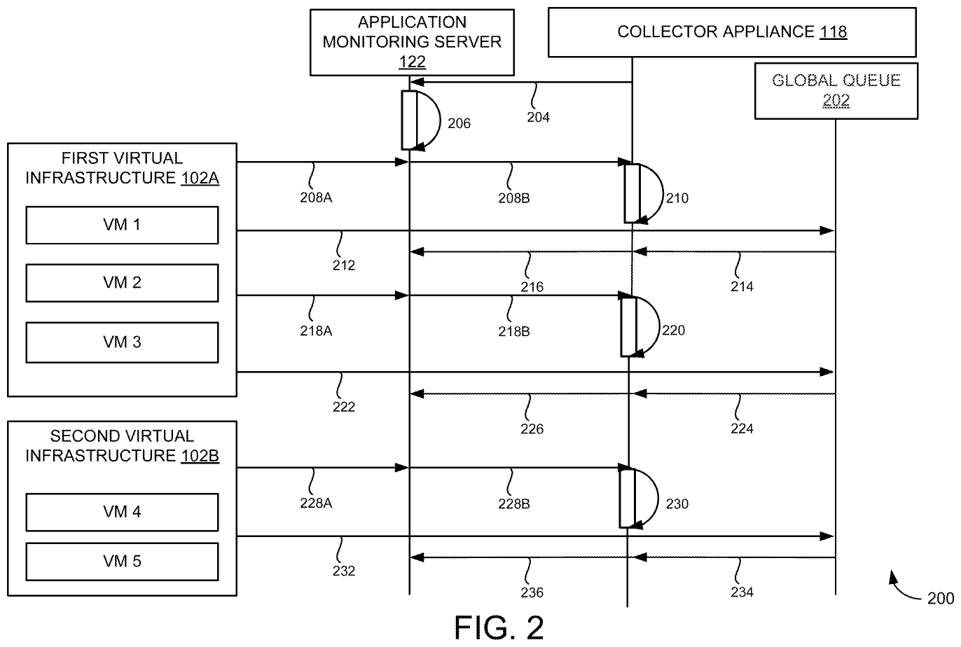

FIG. 2 is a sequence diagram 200 illustrating sequence of events to configure a single adapter instance for monitoring multiple virtual infrastructures. For example, similarly named elements of FIG. 2 may be similar in structure and/or function to elements described with respect to FIG. 1. The sequence diagram may represent the interactions and the operations involved in configuring the single adapter instance to monitor multiple virtual infrastructures. FIG. 2 illustrates process objects including application monitoring server 122, collector appliance 118, and a global queue 202 along with their respective vertical lines originating from them. The vertical lines of application monitoring server 122, collector appliance 118, and global queue 202 may represent the processes that may exist simultaneously. The horizontal arrows (e.g., 204, 208A, 208B, 212, 214, 216, 218A, 218B, 222, 224, 226, 228A, 228B, 232, 234, and 236) may represent the data flow steps between the vertical lines originating from their respective process objects (for e.g., application monitoring server 122 and collector appliance 118). Further, activation boxes (e.g., 206, 210, 220, and 230) between the horizontal arrows may represent the process that is being performed in the respective process object.

At 204, a new collector appliance 118 (e.g., a cloud proxy) may be added to application monitoring server 122 (i.e., a tool which leverages the power of artificial intelligence to facilitate monitoring, troubleshooting, and manage virtual infrastructures such as vROps). During a first boot of collector appliance 118, at 206, application monitoring server 122 may generate an adapter instance (e.g., an App OS adapter) for newly added collector appliance 118.

At 208A, application monitoring server 122 may receive, via a graphical user interface, a request to bootstrap a first virtual computing instance (e.g., VM1) running in a first virtual infrastructure (e.g., vCenter1 (VC1)). At 208B, application monitoring server 122 may forward the request to collector appliance 118. At 210, collector appliance 118 may check whether VC1 is mapped to collector appliance 118. When the VCI is not mapped to collector appliance 118, collector appliance 118 may add the VC1 to an identifier of collector appliance 118 and then continue to perform the bootstrapping process using the adapter instance.

Upon bootstrapping the VM1, at 212, performance metrics such as operating system and application metrics of VM1 may be sent to global queue 202 of collector appliance 118. At 214, collector appliance 118 may read the performance metrics from global queue 202. At 216, collector appliance 118 may send the performance metrics to application monitoring server 122.

At 218A, application monitoring server 122 may receive, via a graphical user interface, a request to bootstrap a second virtual computing instance (e.g., VM2) running in a first virtual infrastructure (e.g., vCenter1 (VC1)). At 218B, application monitoring server 122 may forward the request to collector appliance 118. Since VCI is already mapped to collector appliance 118, at 220, collector appliance 118 may continue to perform the bootstrapping of VM2 using the adapter instance. At 222, the performance metrics of VM2 may be sent to global queue 202. At 224, collector appliance 118 may read the performance metrics of VM2 from global queue 202. At 226, collector appliance 118 may send the performance metrics of VM2 to application monitoring server 122.

At 228A, application monitoring server 122 may receive, via a graphical user interface, a request to bootstrap a fourth virtual computing instance (e.g., VM4) running in second virtual infrastructure (e.g., vCenter2 (VC2)). At 228B, application monitoring server 122 may forward the request to collector appliance 118. At 230, as VC2 is not mapped to collector appliance 118, collector appliance 118 may add VC2 to the identifier of collector appliance 118 and then continue to perform bootstrapping of VM4 using the adapter instance. In this example, bootstrapping may be continued using the same adapter for all the VCs mapped to collector appliance 118. At 232, the performance metrics of VM4 may be sent to global queue 202. Thus, all VMs in VC1 and VC2 continue to use the same global queue 202 for sending metrics. At 234, collector appliance 118 may read the performance metrics from global queue 202. At 236, collector appliance 118 may send the performance metrics to application monitoring server 122. Thus, examples described herein may provide an approach to resolve both the resource utilization issues as well as management challenges by creating a single adapter instance that can cater any number of virtual infrastructure (e.g., vCenter) configurations.

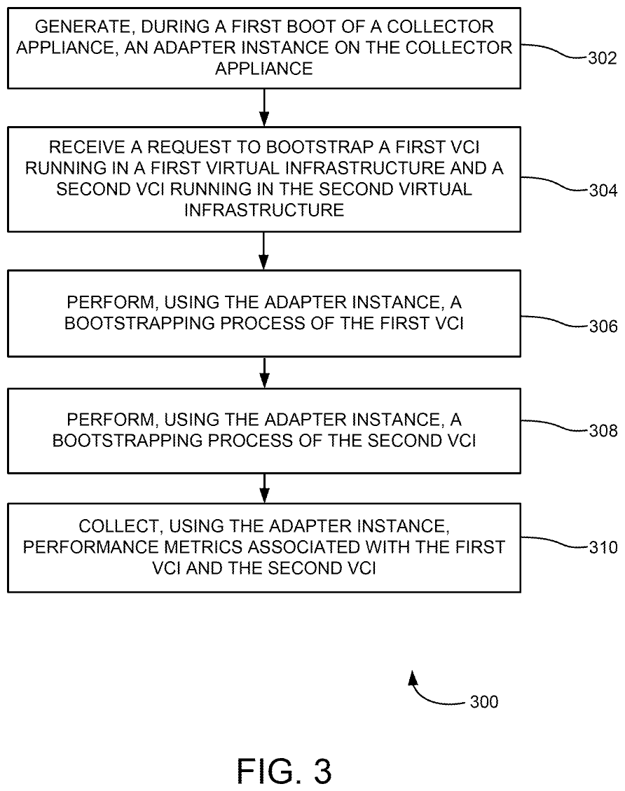

FIG. 3 is a flow diagram illustrating an example method 300 for configuring a single adapter instance to monitor multiple virtual infrastructures. Example method 300 depicted in FIG. 3 represents generalized illustrations, and other processes may be added, or existing processes may be removed, modified, or rearranged without departing from the scope and spirit of the present application. In addition, method 300 may represent instructions stored on a computer-readable storage medium that, when executed, may cause a processor to respond, to perform actions, to change states, and/or to make decisions. Alternatively, method 300 may represent functions and/or actions performed by functionally equivalent circuits like analog circuits, digital signal processing circuits, application specific integrated circuits (ASICs), or other hardware components associated with the system. Furthermore, the flow charts are not intended to limit the implementation of the present application, but the flow charts illustrate functional information to design/fabricate circuits, generate computer-readable instructions, or use a combination of hardware and computer-readable instructions to perform the illustrated processes.

At 302, during a first boot of a collector appliance, an adapter instance may be generated on the collector appliance. At 304, a request may be received to bootstrap a first virtual computing instance (VCI) running in a first virtual infrastructure managed by a first virtual infrastructure manager (VIM) and a second VCI running in a second virtual infrastructure managed by a second VIM.

Upon receiving the request, a bootstrapping process of the first VCI to map the adapter instance to the first virtual infrastructure and to install a first monitoring agent may be performed using the adapter instance, at 306. Further, at 308, a bootstrapping process of the second VCI to map the adapter instance to the second virtual infrastructure and to install a second monitoring agent may be performed.

In an example, performing the bootstrapping process of the first VCI and the second VCI to map the adapter instance to the first virtual infrastructure and the second virtual infrastructure may include determining whether the first virtual infrastructure and the second virtual infrastructure are mapped to the adapter instance. In response to determining that the first virtual infrastructure, the second virtual infrastructure, or both are not mapped to the adapter instance, the first virtual infrastructure, the second virtual infrastructure, or both may be added to the adapter instance.

In an example, performing the bootstrapping process of the first VCI may include retrieving a first security certificate of the first virtual infrastructure from a virtual infrastructure management adapter deployed in the first VIM in response to initiating the bootstrapping process of the first VCI based on the request. Further, the bootstrapping process of the first VCI running in the first virtual infrastructure may be performed using the first security certificate.

In an example, performing the bootstrapping process of the second VCI may include retrieving a second security certificate of the second virtual infrastructure from a virtual infrastructure management adapter deployed in the second VIM in response to initiating the bootstrapping process of the second VCI based on the request. Further, the bootstrapping process of the second VCI running in the second virtual infrastructure may be performed using the second security certificate.

In an example, a request to bootstrap a third VCI running in the first virtual infrastructure may be received. In response to initiating the bootstrapping process of the third VCI based on the request to bootstrap the third VCI, the first security certificate of the first virtual infrastructure may be retrieved from the virtual infrastructure management adapter deployed in the first VIM. Further, the bootstrapping process of the third VCI running in the first virtual infrastructure may be performed using the first security certificate to install the third monitoring agent. For example, the adapter instance in the collector appliance may be responsible to collect performance metrics of VCIs running in the virtual infrastructures and infrastructure management adapters in the virtual infrastructures may be responsible to collect data (e.g., certificates) of the virtual infrastructures.

At 310, performance metrics associated with the first VCI and the second VCI may be collected from the first monitoring agent and the second monitoring agent, respectively, using the adapter instance. Further, the performance metrics associated with the first VCI and the second VCI may be sent to a monitoring application for monitoring and troubleshooting the first VCI and the second VCI.

In an example, collecting the performance metrics may include generating a global queue corresponding to the first virtual infrastructure and the second virtual infrastructure in the adapter instance. Further, the performance metrics associated with the first VCI and the second VCI may be collected from the first monitoring agent and the second monitoring agent, respectively, into the global queue using the adapter instance.

In another example, collecting the performance metrics may include generating a first queue and a second queue corresponding to the first virtual infrastructure and the second virtual infrastructure, respectively, in the adapter instance. Further, the performance metrics associated with the first VCI may be collected from the first monitoring agent into the first queue collecting using the adapter instance. Furthermore, the performance metrics associated with the second VCI may be collected from the second monitoring agent into the second queue using the adapter instance.

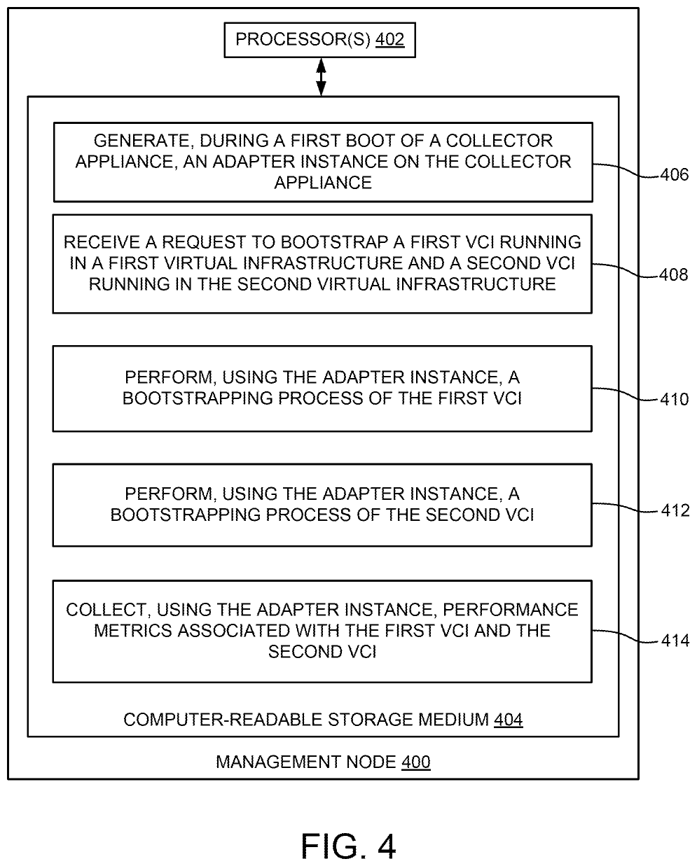

FIG. 4 is a block diagram of an example management node including non-transitory computer-readable storage medium 404 storing instructions to configure a single adapter instance to monitor multiple virtual infrastructures. Management node 400 may include a processor 402 and computer-readable storage medium 404 communicatively coupled through a system bus. Processor 402 may be any type of central processing unit (CPU), microprocessor, or processing logic that interprets and executes computer-readable instructions stored in computer-readable storage medium 404. Computer-readable storage medium 404 may be a random-access memory (RAM) or another type of dynamic storage device that may store information and computer-readable instructions that may be executed by processor 402. For example, computer-readable storage medium 404 may be synchronous DRAM (SDRAM), double data rate (DDR), Rambus® DRAM (RDRAM), Rambus® RAM, etc., or storage memory media such as a floppy disk, a hard disk, a CD-ROM, a DVD, a pen drive, and the like. In an example, computer-readable storage medium 404 may be a non-transitory computer-readable medium. In an example, computer-readable storage medium 404 may be remote but accessible to management node 400.

Computer-readable storage medium 404 may store instructions 406, 408, 410, 412, and 414. During a first boot of a collector appliance, instructions 406 may be executed by processor 402 to generate an adapter instance on the collector appliance. Instructions 408 may be executed by processor 402 to receive a request to bootstrap a first virtual computing instance (VCI) running in a first virtual infrastructure managed by a first virtual infrastructure manager (VIM) and a second VCI running in the second virtual infrastructure managed by a second VIM.

Upon receiving the request, instructions 410 may be executed by processor 402 to perform, using the adapter instance, a bootstrapping process of the first VCI to map the adapter instance to the first virtual infrastructure and to install a first monitoring agent. Further, instructions 412 may be executed by processor 402 to perform, using the adapter instance, a bootstrapping process of the second VCI to map the adapter instance to the second virtual infrastructure and to install a second monitoring agent.

In an example, instructions 410 and 412 to perform the bootstrapping process of the first VCI and the second VCI may include instructions to determine whether the first virtual infrastructure and the second virtual infrastructure are mapped to the adapter instance. In response to determining that the first virtual infrastructure, the second virtual infrastructure, or both are not mapped to the adapter instance, the first virtual infrastructure, the second virtual infrastructure, or both may be added to the adapter instance.

In an example, instructions 410 to perform the bootstrapping process of the first VCI may include instructions to retrieve a first security certificate of the first virtual infrastructure from a virtual infrastructure management adapter deployed in the first VIM in response to initiating the bootstrapping process of the first VCI. Further, the bootstrapping process of the first VCI running in the first virtual infrastructure may be performed using the first security certificate.

Further, computer-readable storage medium 404 may store instructions to receive a request to bootstrap a third VCI running in the first virtual infrastructure. In response to initiating the bootstrapping process of the third VCI, the first security certificate of the first virtual infrastructure may be retrieved from the virtual infrastructure management adapter deployed in the first VIM. Further, the bootstrapping process of the third VCI running in the first virtual infrastructure may be performed using the first security certificate to install the third monitoring agent.

In an example, instructions 412 to perform the bootstrapping process of the second VCI may include instructions to retrieve a second security certificate of the second virtual infrastructure from a virtual infrastructure management adapter deployed in the second VIM in response to initiating the bootstrapping process of the second VCI. Further, the bootstrapping process of the second VCI running in the second virtual infrastructure may be performed using the second security certificate.

Instructions 414 may be executed by processor 402 to collect, using the adapter instance, performance metrics associated with the first VCI and the second VCI from the first monitoring agent and the second monitoring agent, respectively.

The above-described examples are for the purpose of illustration. Although the above examples have been described in conjunction with example implementations thereof, numerous modifications may be possible without materially departing from the teachings of the subject matter described herein. Other substitutions, modifications, and changes may be made without departing from the spirit of the subject matter. Also, the features disclosed in this specification (including any accompanying claims, abstract, and drawings), and any method or process so disclosed, may be combined in any combination, except combinations where some of such features are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus. In addition, the terms “first” and “second” are used to identify individual elements and may not meant to designate an order or number of those elements.

The present description has been shown and described with reference to the foregoing examples. It is understood, however, that other forms, details, and examples can be made without departing from the spirit and scope of the present subject matter that is defined in the following claims.

What is claimed is:

1. A method comprising:
generating, during a first boot of a collector appliance, an adapter instance on the collector appliance;
receiving a request to bootstrap a first virtual computing instance (VCI) running in a first virtual infrastructure managed by a first virtual infrastructure manager (VIM) and a second VCI running in a second virtual infrastructure managed by a second VIM;
upon receiving the request, performing, using the adapter instance, a bootstrapping process of:
the first VCI to map the adapter instance to the first virtual infrastructure and to install a first monitoring agent; and
the second VCI to map the adapter instance to the second virtual infrastructure and to install a second monitoring agent; and
collecting, using the adapter instance, performance metrics associated with the first VCI and the second VCI from the first monitoring agent and the second monitoring agent, respectively.

2. The method of claim 1, further comprising:
sending the performance metrics associated with the first VCI and the second VCI to a monitoring application for monitoring and troubleshooting the first VCI and the second VCI.

3. The method of claim 1, wherein performing the bootstrapping process of the first VCI and the second VCI to map the adapter instance to the first virtual infrastructure and the second virtual infrastructure comprises:
determining whether the first virtual infrastructure and the second virtual infrastructure are mapped to the adapter instance; and
in response to determining that the first virtual infrastructure, the second virtual infrastructure, or both are not mapped to the adapter instance, adding the first virtual infrastructure, the second virtual infrastructure, or both to the adapter instance.

4. The method of claim 1, wherein collecting the performance metrics comprises:
generating a global queue corresponding to the first virtual infrastructure and the second virtual infrastructure in the adapter instance; and
collecting, using the adapter instance, the performance metrics associated with the first VCI and the second VCI from the first monitoring agent and the second monitoring agent, respectively, into the global queue.

5. The method of claim 1, wherein collecting the performance metrics comprises:
generating a first queue and a second queue corresponding to the first virtual infrastructure and the second virtual infrastructure, respectively, in the adapter instance;
collecting, using the adapter instance, the performance metrics associated with the first VCI from the first monitoring agent into the first queue; and
collecting, using the adapter instance, the performance metrics associated with the second VCI from the second monitoring agent into the second queue.

6. The method of claim 1, wherein performing the bootstrapping process of the first VCI comprises:
in response to initiating the bootstrapping process of the first VCI based on the request, retrieving a first security certificate of the first virtual infrastructure from a virtual infrastructure management adapter deployed in the first VIM; and
performing, using the first security certificate, the bootstrapping process of the first VCI running in the first virtual infrastructure.

7. The method of claim 6, further comprising:
receiving a request to bootstrap a third VCI running in the first virtual infrastructure;
in response to initiating the bootstrapping process of the third VCI based on the request to bootstrap the third VCI, retrieving the first security certificate of the first virtual infrastructure from the virtual infrastructure management adapter deployed in the first VIM; and
performing, using the first security certificate, the bootstrapping process of the third VCI running in the first virtual infrastructure to install the third monitoring agent.

8. The method of claim 1, wherein performing the bootstrapping process of the second VCI comprises:
in response to initiating the bootstrapping process of the second VCI based on the request, retrieving a second security certificate of the second virtual infrastructure from a virtual infrastructure management adapter deployed in the second VIM; and
performing, using the second security certificate, the bootstrapping process of the second VCI running in the second virtual infrastructure.

9. A management node comprising:
a processor; and
memory coupled to the processor, wherein the memory comprises a management application to:
deploy a collector appliance corresponding to a monitoring application;
generate, during a first boot of the collector appliance, an adapter instance on the collector appliance;
receive a request to bootstrap a first virtual computing instance (VCI) of a first virtual infrastructure managed by a first virtual infrastructure manager (VIM) and a second VCI of a second virtual infrastructure managed by a second VIM;
perform, using the adapter instance, a bootstrapping process of the first VCI and the second VCI to install a first monitoring agent and a second monitoring agent, respectively; and
collect, using the adapter instance, performance metrics of an operating system and/or an application associated with the first VCI and the second VCI from the first monitoring agent and the second monitoring agent, respectively.

10. The management node of claim 9, wherein the management application is to:
determine whether the first virtual infrastructure and the second virtual infrastructure are mapped to the adapter instance; and
in response to determining that the first virtual infrastructure, the second virtual infrastructure, or both are not mapped to the adapter instance, perform, using the adapter instance, the bootstrapping process of the first VCI and the second VCI to:
map the first virtual infrastructure, the second virtual infrastructure, or both to the adapter instance; and
install the first monitoring agent and the second monitoring agent in the first VCI and the second VCI, respectively.

11. The management node of claim 9, wherein the management application is to:
generate a global queue corresponding to the first virtual infrastructure and the second virtual infrastructure in the adapter instance; and
collect, using the adapter instance, the performance metrics of the operating system and/or the application associated with the first VCI and the second VCI from the first monitoring agent and the second monitoring agent, respectively, into the global queue.

12. The management node of claim 9, wherein the management application is to:
generate a first queue and a second queue corresponding to the first virtual infrastructure and the second virtual infrastructure, respectively, in the adapter instance;
collect, using the adapter instance, the performance metrics of the operating system and/or the application associated with the first VCI managed by the first VIM into the first queue; and
collect, using the adapter instance, the performance metrics of the operating system and/or the application associated with the second VCI managed by the second VIM into the second queue.

13. The management node of claim 9, wherein the management application is to:
in response to receiving the request to bootstrap the first VCI, retrieve a first security certificate of the first virtual infrastructure from a virtual infrastructure management adapter deployed in the first VIM; and
perform, using the first security certificate, the bootstrapping process of the first VCI running in the first virtual infrastructure.

14. The management node of claim 13, wherein the management application is to:
receive a request to initiate the bootstrapping process of a third VCI running in the first virtual infrastructure;
in response to initiating the bootstrapping process of the third VCI, retrieve the first security certificate of the first virtual infrastructure from the virtual infrastructure management adapter deployed in the first VIM; and
perform, using the first security certificate, the bootstrapping process of the third VCI running in the first virtual infrastructure to install the third monitoring agent.

15. The management node of claim 9, wherein the management application is to:
in response to receiving the request to bootstrap the second VCI, retrieve a second security certificate of the second virtual infrastructure from a virtual infrastructure management adapter deployed in the second VIM; and
perform, using the second security certificate, the bootstrapping process of the second VCI running in the second virtual infrastructure.

16. A non-transitory computer-readable storage medium storing instructions executable by a processor of a management node to:
generate, during a first boot of a collector appliance, an adapter instance on the collector appliance;
receive a request to bootstrap a first virtual computing instance (VCI) running in a first virtual infrastructure managed by a first virtual infrastructure manager (VIM) and a second VCI running in the second virtual infrastructure managed by a second VIM;
upon receiving the request, perform, using the adapter instance, a bootstrapping process of:
the first VCI to map the adapter instance to the first virtual infrastructure and to install a first monitoring agent; and
the second VCI to map the adapter instance to the second virtual infrastructure and to install a second monitoring agent; and
collect, using the adapter instance, performance metrics associated with the first VCI and the second VCI from the first monitoring agent and the second monitoring agent, respectively.

17. The non-transitory computer-readable storage medium of claim 16, wherein instructions to perform the bootstrapping process of the first VCI and the second VCI comprise instructions to:
determine whether the first virtual infrastructure and the second virtual infrastructure are mapped to the adapter instance; and
in response to determining that the first virtual infrastructure, the second virtual infrastructure, or both are not mapped to the adapter instance, add the first virtual infrastructure, the second virtual infrastructure, or both to the adapter instance.

18. The non-transitory computer-readable storage medium of claim 16, wherein instructions to collect the performance metrics comprise instructions to:
generate a global queue corresponding to the first virtual infrastructure and the second virtual infrastructure in the adapter instance; and
collect, using the adapter instance, the performance metrics of an operating system and/or an application associated with the first VCI and the second VCI from the first monitoring agent and the second monitoring agent, respectively, into the global queue.

19. The non-transitory computer-readable storage medium of claim 16, wherein instructions to perform the bootstrapping process of the first VCI comprise instructions to:
in response to initiating the bootstrapping process of the first VCI, retrieve a first security certificate of the first virtual infrastructure from a virtual infrastructure management adapter deployed in the first VIM; and
perform, using the first security certificate, the bootstrapping process of the first VCI running in the first virtual infrastructure.

20. The non-transitory computer-readable storage medium of claim 19, further comprising instructions to:
receive a request to bootstrap a third VCI running in the first virtual infrastructure;
in response to initiating the bootstrapping process of the third VCI, retrieve the first security certificate of the first virtual infrastructure from the virtual infrastructure management adapter deployed in the first VIM; and
perform, using the first security certificate, the bootstrapping process of the third VCI running in the first virtual infrastructure to install the third monitoring agent.

21. The non-transitory computer-readable storage medium of claim 16, wherein instructions to perform the bootstrapping process of the second VCI comprise instructions to:
in response to initiating the bootstrapping process of the second VCI, retrieve a second security certificate of the second virtual infrastructure from a virtual infrastructure management adapter deployed in the second VIM; and
perform, using the second security certificate, the bootstrapping process of the second VCI running in the second virtual infrastructure.
